(19) United States
(12) Patent Application Publication
(10) Pub. No.: US 2020/0000658 A1
(43) Pub. Date: Jan. 2, 2020

(54) Mobility Platform System Method Detachable Assembly and Interconnection Mechanism for Wheelchairs and Fitted Rickshaws

(71) Applicants: Keren Klein, Herzeliya (IL); Offer Halpern, Tel-Aviv (IL)

(72) Inventors: Keren Klein, Herzeliya (IL); Offer Halpern, Tel-Aviv (IL)

(21) Appl. No.: 16/459,857

(22) Filed: Jul. 2, 2019

Related U.S. Application Data
(60) Provisional application No. 62/692,963, filed on Jul. 2, 2018.

(51) Int. Cl. A61G 5/04

(52) U.S. Cl. CPC A61G 5/047; A61G 5/003; A61G 5/045

(57) ABSTRACT

Disclosed is a mobility platform, system, method and, a detachable wheelchair and rickshaw drive assembly (Electric Mobility Attachment) including a chassis connected to a front and rear unit, each unit comprising a respective electrically motorized wheel. The chassis includes an interlocking element extending towards and interfacing-with a structural element on the frame of a wheelchair, such that forward force applied onto the chassis by the front and rear wheels, is conveyed to the wheelchair by the interlocking element, thereby propelling it forward.

### RELATED APPLICATIONS SECTION

The present application claims priority from U.S. Provisional Patent Application No. 62/692,963, filed Jul. 2, 2018, which application is hereby incorporated by reference in its entirety.

### FIELD OF THE INVENTION

The present invention generally relates to the fields of mobility solutions, mobility and accessibility solutions for the handicapped or disabled, and wheelchair design; and, more particularly, to a mobility platform, system, method, detachable assembly/drive-unit and interconnection mechanism for wheelchairs and fitted rickshaws.

### BACKGROUND

A motorized wheelchair, power chair, electric wheelchair or electric-powered wheelchair (EMT) is a wheelchair that is propelled by means of an electric motor rather than manual power. Motorized wheelchairs are useful for those unable to propel a manual wheelchair or who may need to use a wheelchair for distances or over terrain which would be fatiguing in a manual wheelchair. They may also be used not just by people with ‘traditional’ mobility impairments, but also by people with cardiovascular and fatigue-based conditions.

The existing motorized wheelchairs, and a wide range of existing solutions involving the inclusion of an electric mobility add-on or attachment by use of coupling mechanism, however, suffer from limited maneuverability and access capabilities, and from an installation process and fit which in many cases is too bulky and cumbersome for the user. In addition—electric wheelchair and/or manual wheelchairs using existing geometrical design suffer from inherent instability while sloping, climbing or turning thus requiring the user to be accompanied by a caregiver.

Accordingly, there remains a need, in the fields of: mobility solutions, mobility and accessibility solutions for the handicapped or disabled and, wheelchair design, for general and wheelchair mobility solutions, facilitating new and revised geometrical structures and mechanisms—enabling, carts/rickshaws, existing manual wheelchairs, or wheelchairs having similar integrated capabilities—improved mobility capabilities, such as, but not limited to: forwards and backwards mobility, steeper slope climbing abilities (without tilting over backwards), greater maneuverability, easier access, improved vehicle and user weight distribution, higher level of and easier self-operability and/or other capabilities and advantages.

### SUMMARY OF THE INVENTION

The present invention includes a wheelchair/rickshaw mobility platform, system, method, detachable assembly/drive-unit, and a wheelchair/rickshaw interconnection mechanism.

A chassis, of a wheelchair/rickshaw mobility assembly in accordance with some embodiments, may be connected to a front unit and a rear unit, wherein each unit comprises a respective electrically motorized wheel. The chassis may include an interlocking element extending towards and interfacing-with a structural element on the frame of a wheelchair, such that forward force applied onto the chassis by the front and rear wheels, is conveyed to the wheelchair by the interlocking element, thereby propelling it forward.

According to some embodiments, the interlocking element—interfacing-with the structural element on the frame of a wheelchair—may interface/interlock with the axis of the rear wheels of the wheelchair or specific element(s) thereof.

According to some embodiments, the structure of the chassis, and/or the location of the interlocking element thereon, may position the spinning axis of the rear electrically motorized wheel at, or more rearwards/backwards of, the position of the axis of the rear wheels of a wheelchair, interfaced by the interlocking element of the chassis.

According to some embodiments, the front unit of the assembly may include handlebars for pointing the front wheel of the assembly at the direction in which the assembly, and a wheelchair connected thereto, will travel. According to some embodiments, the structure of the handlebars, the chassis and/or the location of the interlocking element thereon, may position the handlebars substantially in front of, and in a reaching distance of, a user sitting in a wheelchair, interfaced by the interlocking element of the chassis. Pushing of the handlebars in substantially a forward direction may yield the application of an unfolding force onto an axle connecting between the front unit and the chassis—thereby increasing the (top/upper) angle between them.

Increasing the angle between the chassis and the front unit at the axle —the ‘unfolding movement’—may trigger, activate, generate and/or facilitate any combination of the following assembly actions, in response. The assembly actions may be electrically or mechanically triggered by/upon the ‘unfolding movement’ reaching, or passing, specific one or more threshold angles.

Assembly actions, triggered by the unfolding movement may, for example, include: (1) the release one or more breaking mechanisms of the assembly's wheels; (2) the closing/connection of an electric switch or circuit providing power to the electrical motor(s) of the front, the rear, or both of the assembly's wheels; (3) the locking/retention of the axle into an increased—chassis to front unit—angle orientation; (4) the repositioning and/or engaging of the interlocking element to interface, or complete the interfacing (e.g. the locking step of a two-step interlocking process including a first positioning step and then a locking step), with the frame of a wheelchair; and/or (5) the activation of one or more other electrical or mechanical components and/or accessories of the assembly, for example: lights, safety devices, communication components, positioning systems, stabilizing mechanisms, user information input/output components and/or others.

According to some embodiments, the chassis may be connected to the front unit by an axle, wherein decreasing the angle between the chassis and the front unit at the axle, when the assembly is detached from a wheelchair, raises the front unit and front electrically motorized wheel, to fold up, at the axle, and over the chassis—to a folded storage/trolling position/configuration.

According to some embodiments, the chassis of the assembly may comprise a bike seat tube/shaft opening, for accepting and retaining a user/rider seat (e.g. a bicycle seat) or a connection element thereof. When detached from a wheelchair, the assembly may accordingly be used as a standalone electric scooter—in a standing position, where the rider stands on the chassis or a platter/feet-placing connected to its top; or, in a seating position, by connection of the bike seat to the assembly's tube/shaft opening.

According to some embodiments, the interlocking element may be structured to extend towards, face, guide and/or accept, a structural element of/on the frame, or the axis of the rear wheels, of a wheelchair; such that the structural element of/on the frame of a wheelchair driven forward, over and above the back of the assembly, makes-contact/engages with the extended interlocking element.

According to some embodiments, the axle, connecting the chassis to the front unit, may comprise a mechanism for retaining/locking the orientation between the chassis and the front unit at one or more predefined axle-angles.

According to some embodiments, the rear unit electrically motorized wheel may be connected to the chassis by a rear wheel fork. According to some embodiments, the rear wheel fork may be connected to the chassis, substantially at its hack end/section, by an axis facilitating/forming a circular/circle-segment course for movement, for the rear wheel and fork, around the connection axis.

According to some embodiments, a spring/shock-absorber may conned between the back wheel fork or the axis of the back wheel; and, the chassis of the assembly, substantially at its back end/section.

According to some embodiments, the back wheel fork may be connected to the chassis by a back wheel connection shaft, wherein—the back wheel is connected by an axis, as described herein, to the connection shaft on its lower/rear side; and, the connection shaft, on its upper/front side, is pivotally connected to a receiving element on the chassis.

According to some embodiments, a spring biased cable mechanism may run along/within the chassis of the assembly, connecting between the front unit and the rear unit or its rear wheel fork.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings:

In FIG. 1, there is shown an exemplary wheelchair drive assembly, in accordance with some embodiments of the present invention, wherein the assembly is shown in a perspective view;

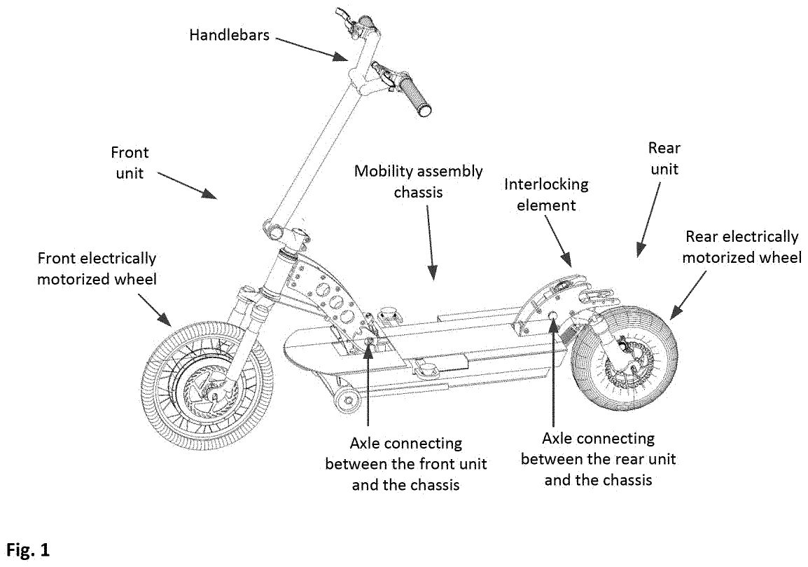

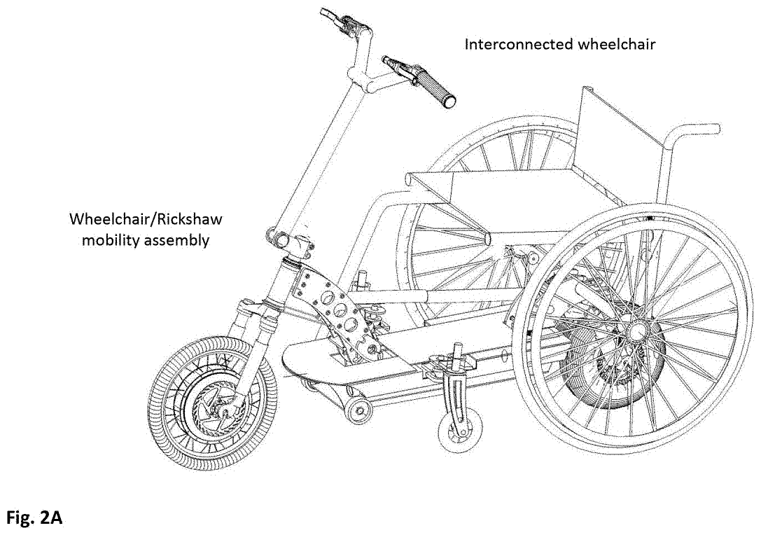

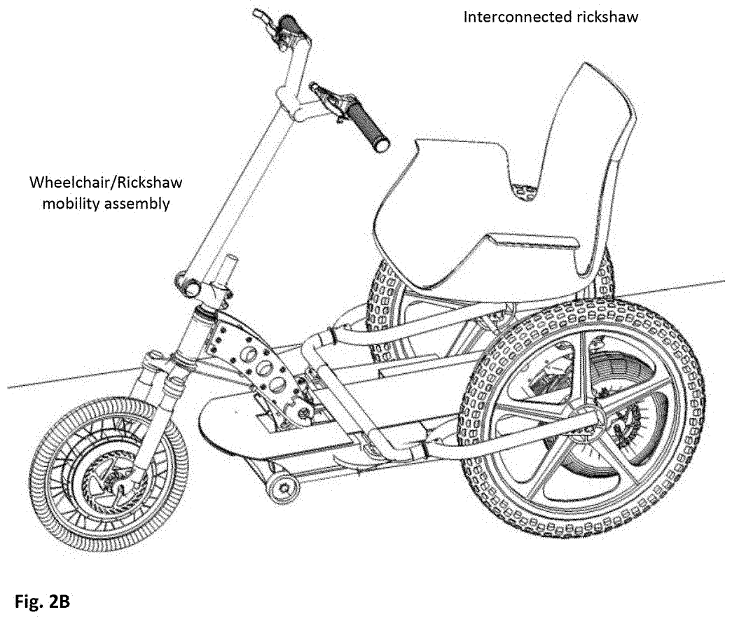

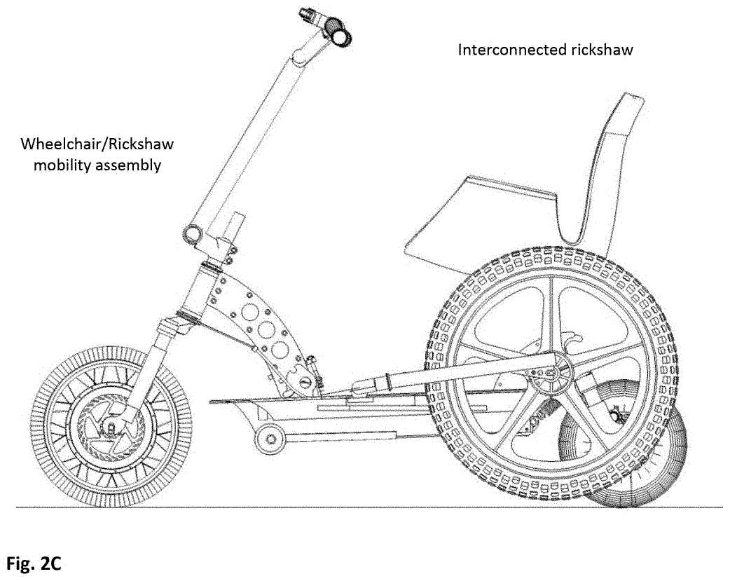

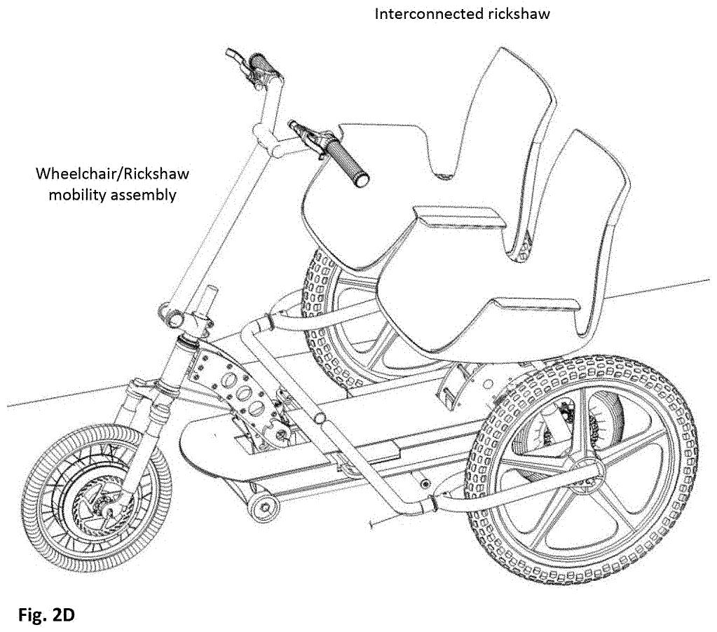

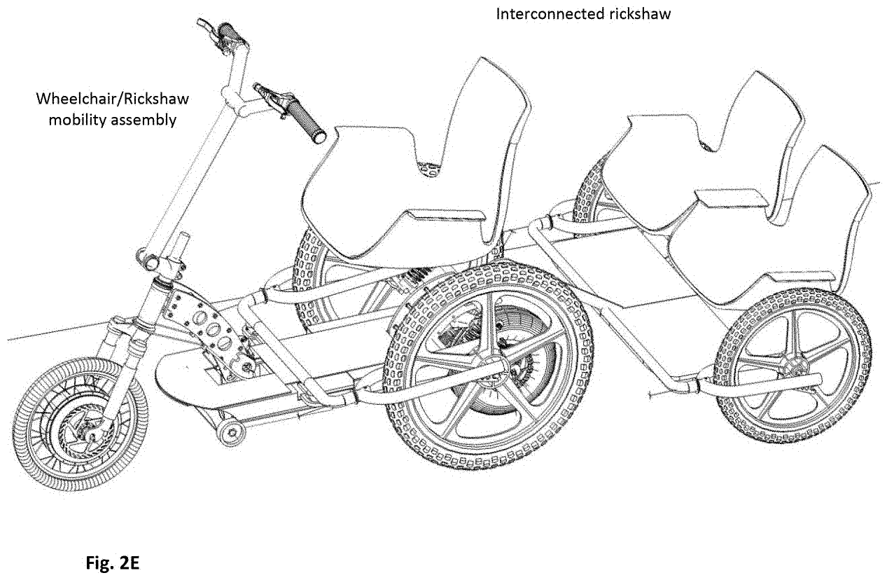

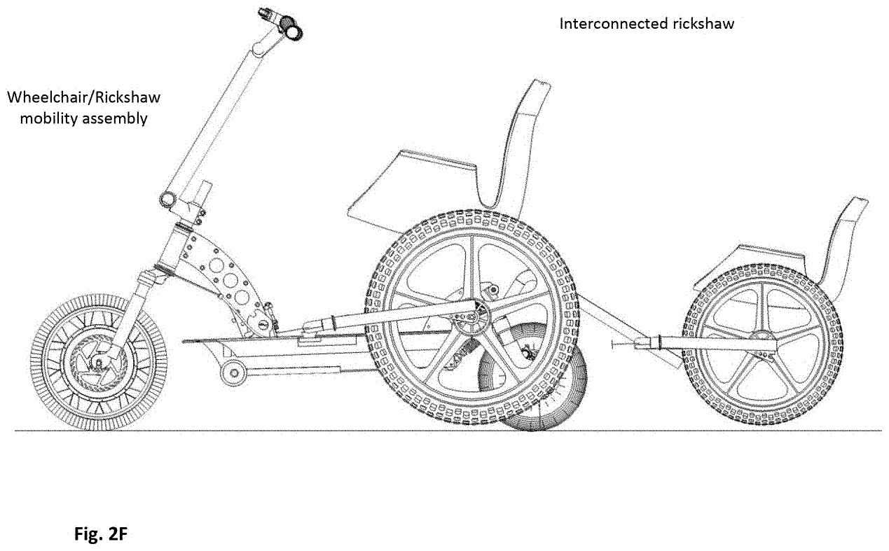

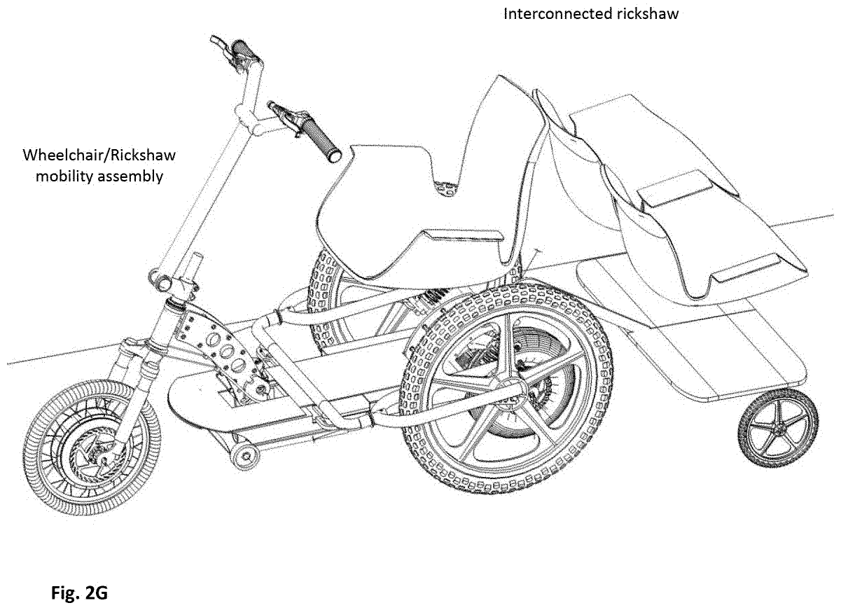

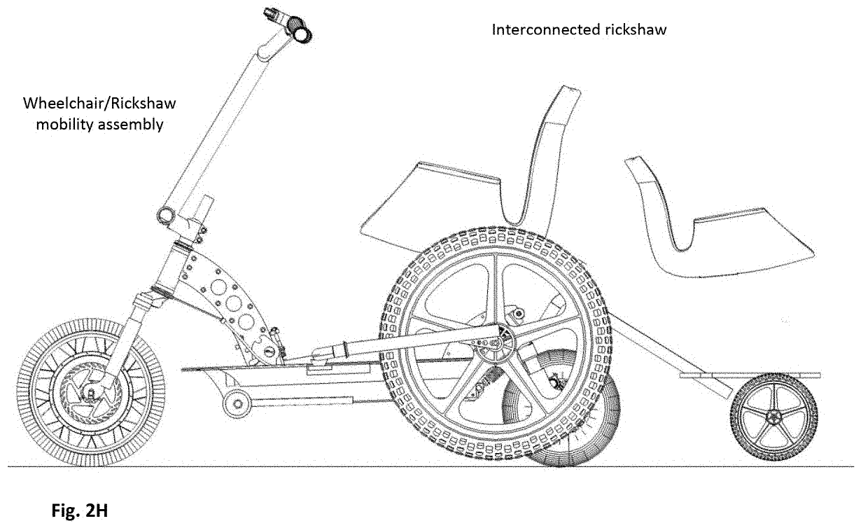

In FIG. 2A, there is shown an exemplary wheelchair drive assembly, in accordance with some embodiments of the present invention, wherein the assembly is shown connected to a wheelchair, in a perspective view;

In FIG. 2B, there is shown an exemplary wheelchair drive assembly, in accordance with some embodiments of the present invention, wherein the assembly is shown connected to a one seat rickshaw, in a perspective view;

In FIG. 2C, there is shown an exemplary wheelchair drive assembly, in accordance with some embodiments of the present invention, wherein the assembly is shown connected to a one seat rickshaw, in a side view;

In FIG. 2D, there is shown an exemplary wheelchair drive assembly, in accordance with some embodiments of the present invention, wherein the assembly is shown connected to a two seat rickshaw, in a perspective view;

In FIG. 2E, there is shown an exemplary wheelchair drive assembly, in accordance with some embodiments of the present invention, wherein the assembly is shown connected to a one front seat and two back seats rickshaw, in a perspective view;

In FIG. 2F, there is shown an exemplary wheelchair drive assembly, in accordance with some embodiments of the present invention, wherein the assembly is shown connected to a one front seat and two back seats rickshaw, in a side view;

In FIG. 2G, there is shown an exemplary wheelchair drive assembly, in accordance with some embodiments of the present invention, wherein the assembly is shown connected to a one front seat and two backward facing back seats rickshaw, in a perspective view;

In FIG. 2H, there is shown an exemplary wheelchair drive assembly, in accordance with some embodiments of the present invention, wherein the assembly is shown connected to a one front seat and two backward facing back seats rickshaw, in a side view;

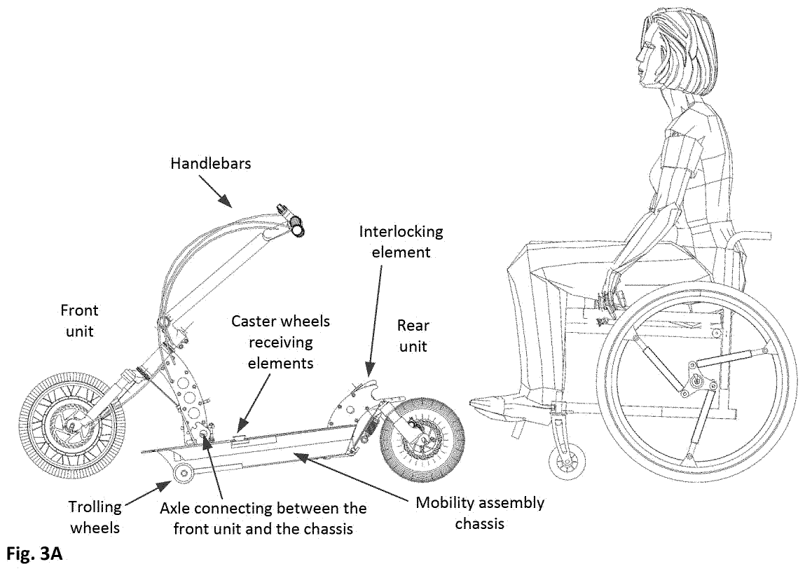

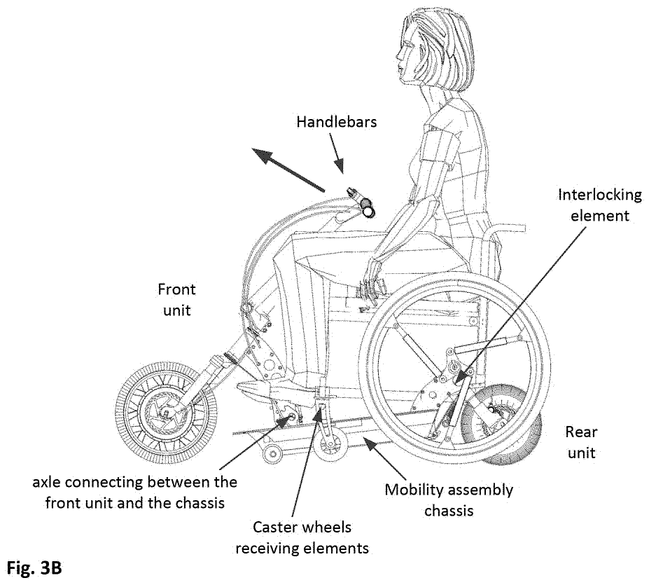

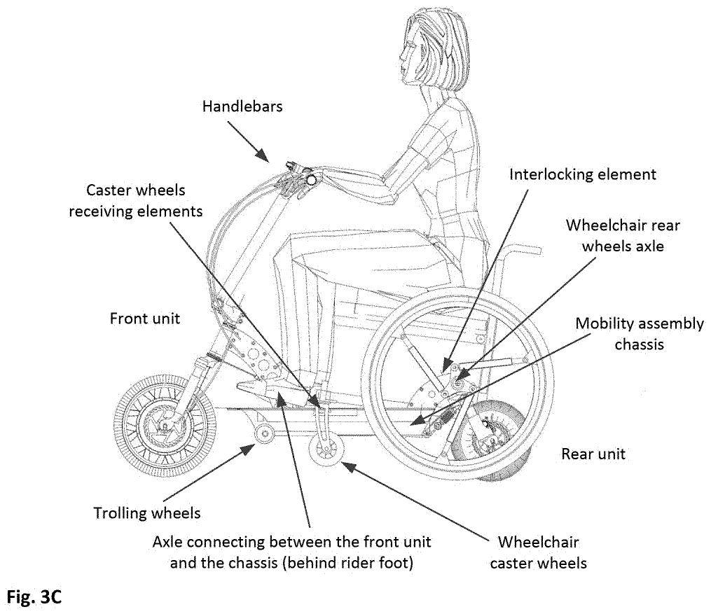

In FIG. 3A, there is shown an exemplary wheelchair drive assembly, in accordance with some embodiments of the present invention, wherein the wheelchair drive assembly is disconnected from a wheelchair positioned behind the assembly, as part of a first stage of a drive assembly to wheelchair interconnection scheme;

In FIG. 3B, there is shown an exemplary wheelchair drive assembly, in accordance with some embodiments of the present invention, wherein the wheelchair drive assembly is disconnected from a wheelchair positioned over/above the assembly, as part of a second stage of a drive assembly to wheelchair interconnection scheme;

In FIG. 3C, there is shown an exemplary wheelchair drive assembly, in accordance with some embodiments of the present invention, wherein the wheelchair drive assembly chassis is unfolded/straightened, a wheelchair is interconnected thereto by an interlocking element engaged with a wheelchair frame element and the wheelchair's caster wheels are raised above ground, as part of a third stage of a drive assembly to wheelchair interconnection scheme;

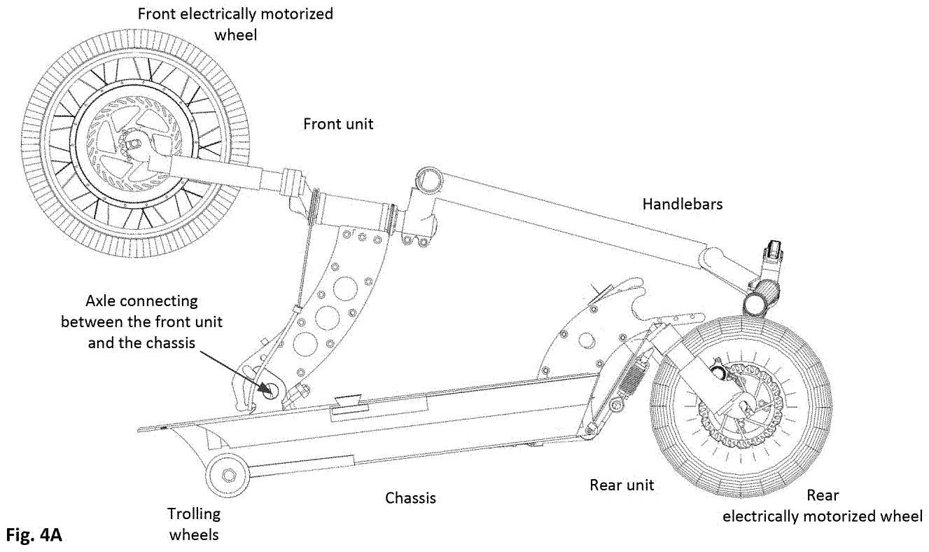

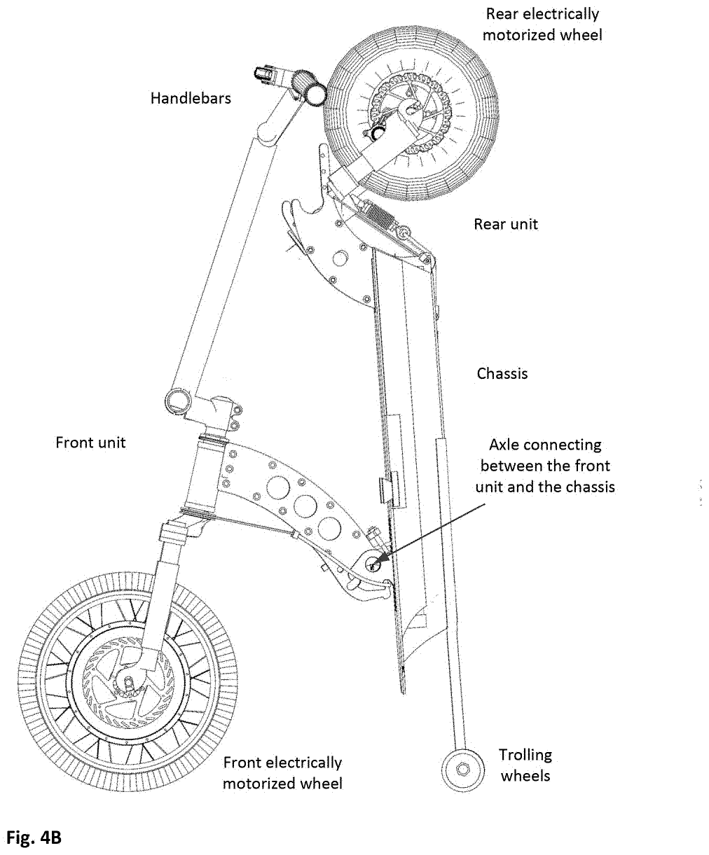

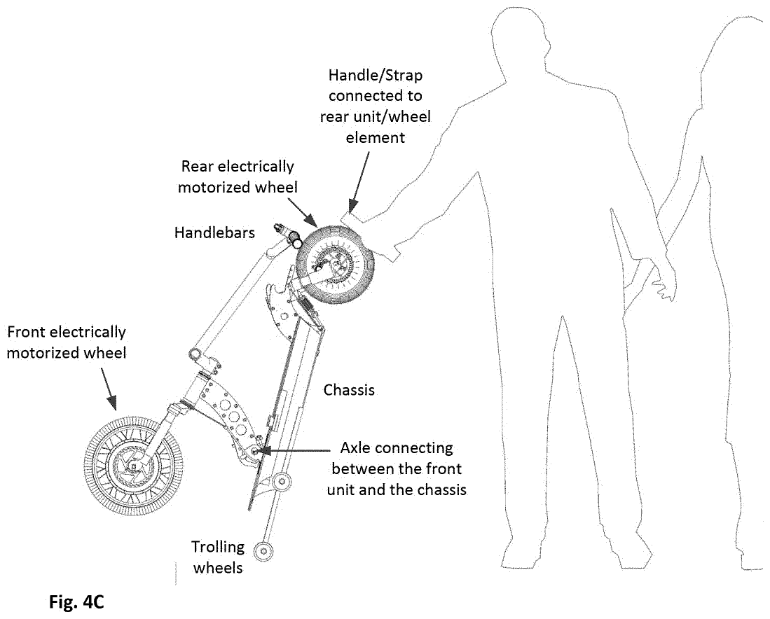

In FIG. 4A, there is shown an exemplary wheelchair drive assembly, in accordance with some embodiments of the present invention, wherein the wheelchair drive assembly is shown with its handlebars and front wheel folded (bent backwards over chassis—lying storage position) and, the assembly's small trolling wheels and rear wheel are in contact with the ground;

In FIG. 4B, there is shown an exemplary wheelchair drive assembly, in accordance with some embodiments of the present invention, wherein the wheelchair drive assembly is shown with its handlebars and front wheel folded (bent backwards over chassis—standing storage position) and, the assembly's small trolling wheels and front wheel are in contact with the ground;

In FIG. 4C, there is shown an exemplary wheelchair drive assembly, in accordance with some embodiments of the present invention, wherein the wheelchair drive assembly is shown with its handlebars and front wheel folded (bent backwards over chassis—tilted trolling position) and, the assembly's small trolling wheels are in contact with the ground;

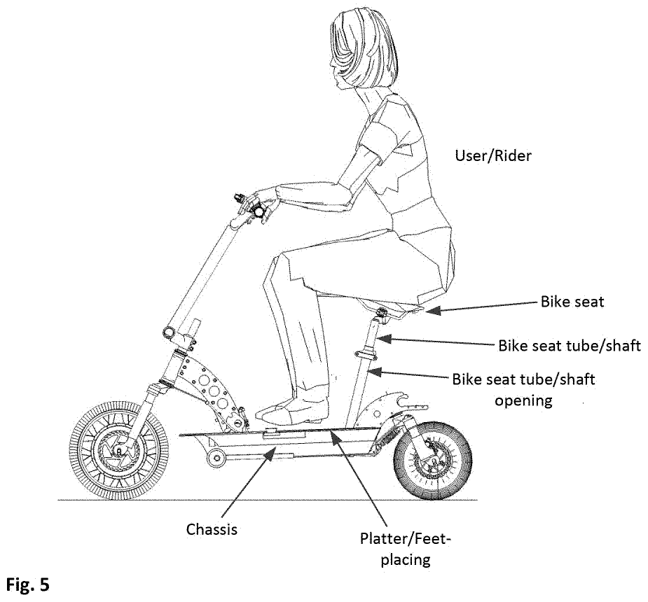

In FIG. 5, there is shown an exemplary wheelchair drive assembly, in accordance with some embodiments of the present invention, wherein the wheelchair drive assembly is shown to include a bike seat positioned above the chassis of the assembly and connected thereto;

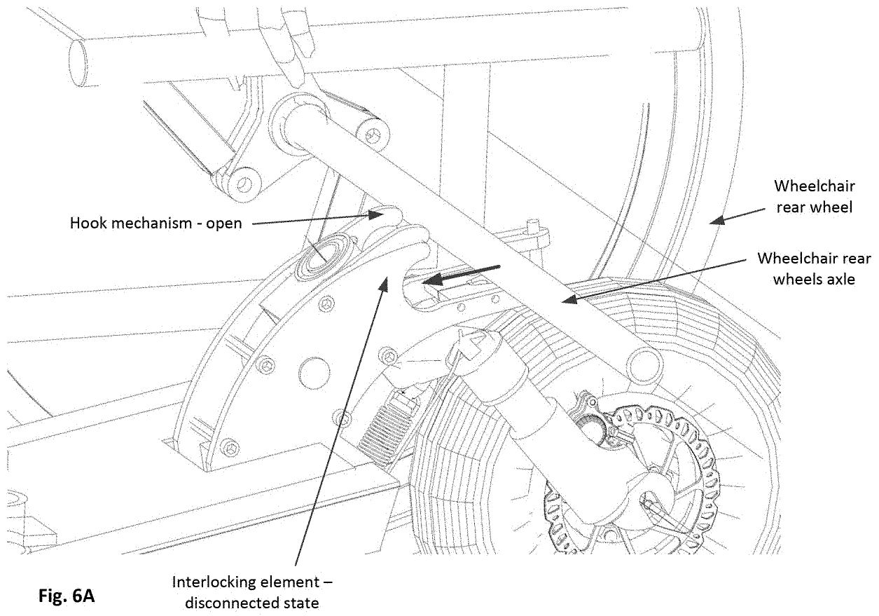

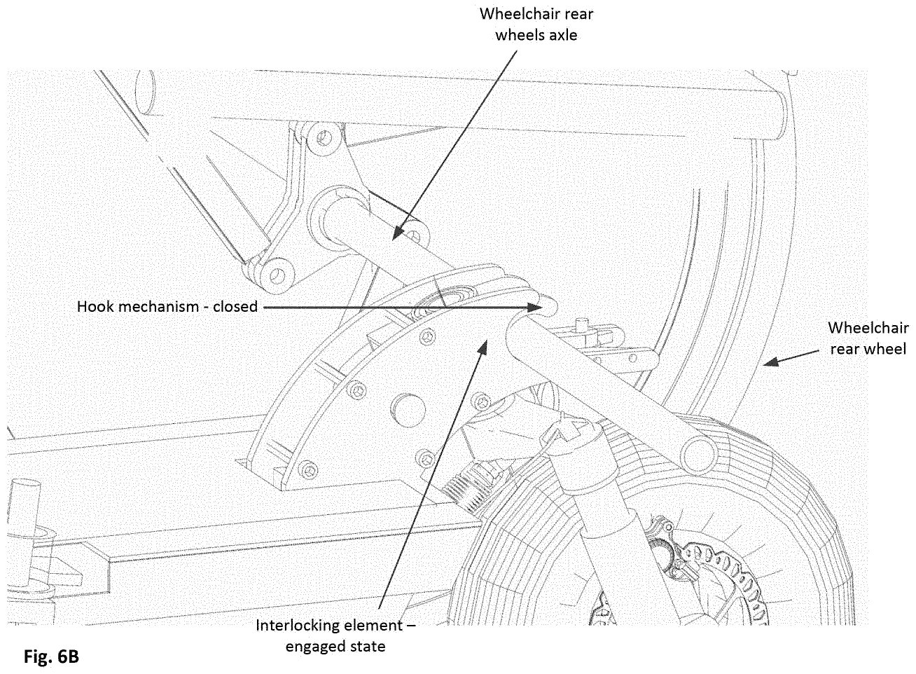

In FIG. 6A, there is shown an exemplary wheelchair drive assembly, in accordance with some embodiments of the present invention, wherein the interlocking element, including main components thereof, is shown in greater detail—in a disconnected state;

In FIG. 6B, there is shown an exemplary wheelchair drive assembly, in accordance with some embodiments of the present invention, wherein the interlocking element, including main components thereof, is shown in greater detail—in an engaged state;

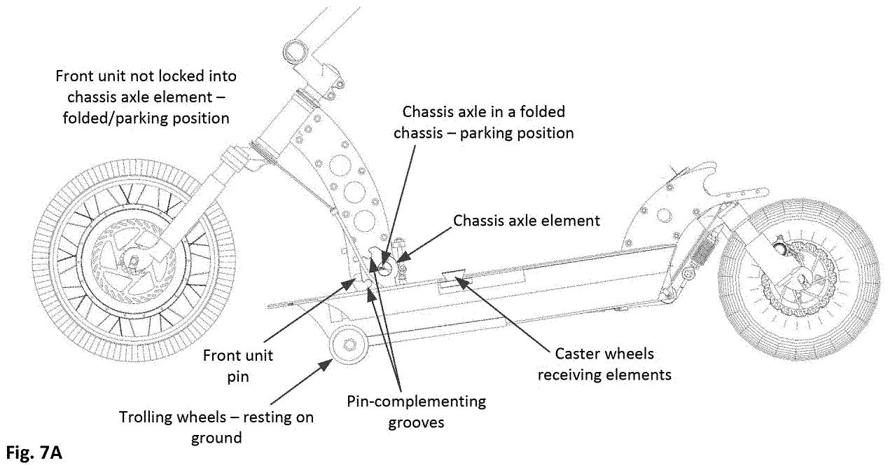

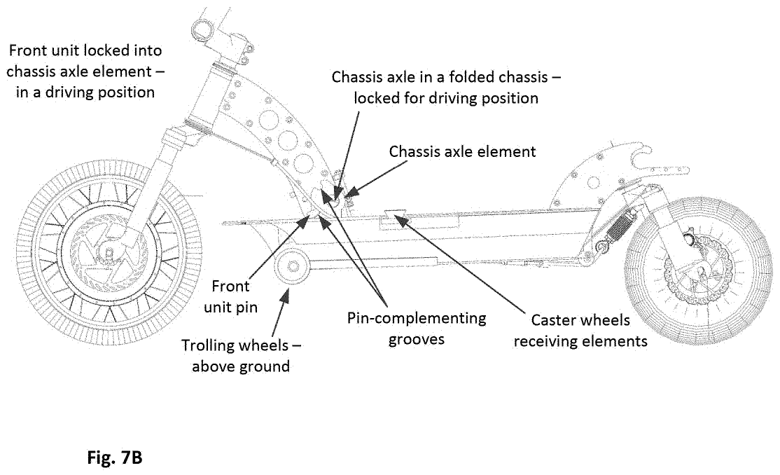

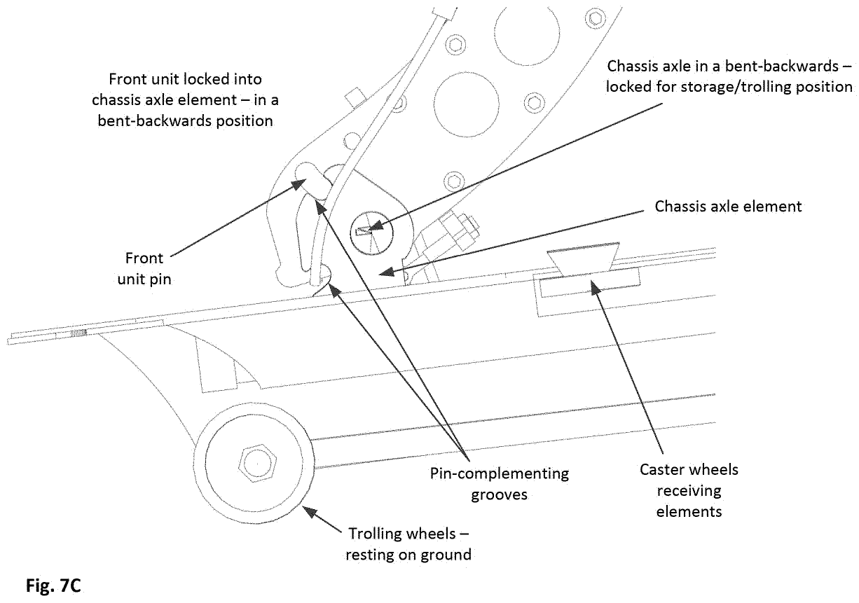

In FIG. 7A, there is shown an exemplary wheelchair drive assembly, in accordance with some embodiments of the present invention, wherein the chassis axle is shown in a folded chassis—parking—position, with the small trolling wheels on ground;

In FIG. 7B, there is shown an exemplary wheelchair drive assembly, in accordance with some embodiments of the present invention, wherein the chassis axle is shown in an unfolded chassis—locked for driving—position, with the small trolling wheels above ground;

In FIG. 7C, there is shown an exemplary wheelchair drive assembly, in accordance with some embodiments of the present invention, wherein the chassis axle is shown in a bent backwards—storage—position, with the small trolling wheels on ground;

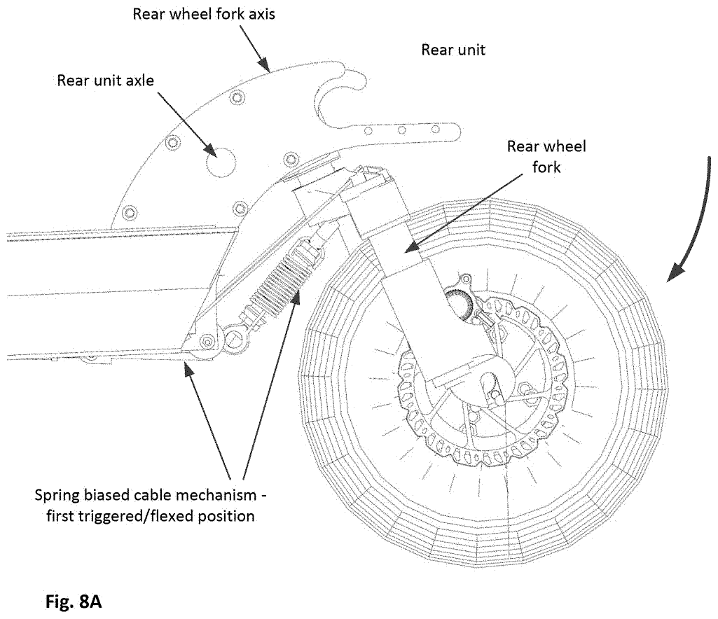

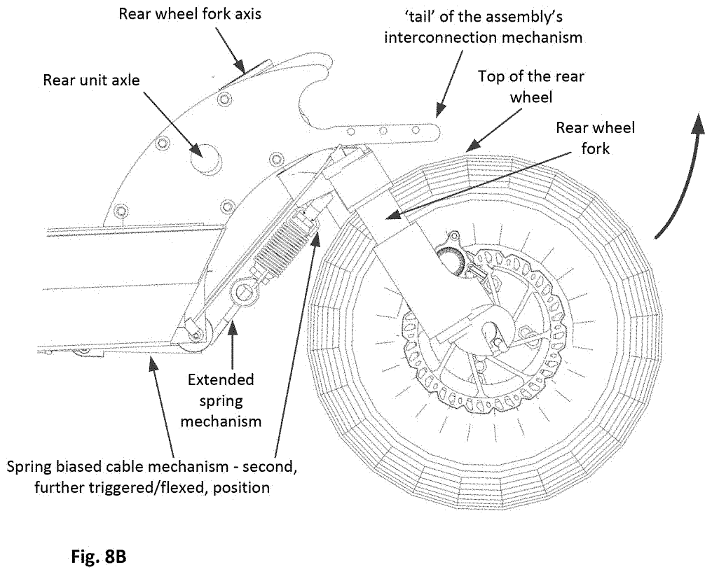

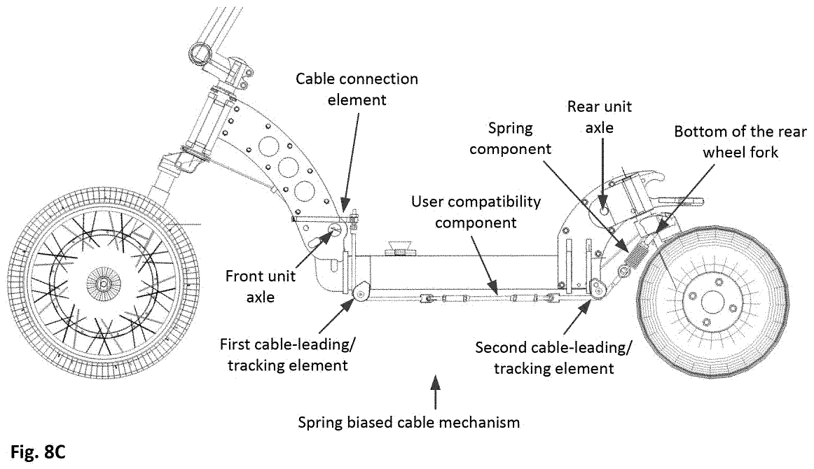

In FIG. 8A, there is shown an exemplary wheelchair drive assembly, in accordance with some embodiments of the present invention, wherein the rear unit and rear wheel are shown in further detail—including a spring biased cable mechanism in a first triggered/flexed position;

In FIG. 8B, there is shown an exemplary wheelchair drive assembly, in accordance with some embodiments of the present invention, wherein the rear unit and rear wheel are shown in further detail—including a spring biased cable mechanism in a second, further triggered/flexed, position;

In FIG. 8C, there is shown a cross section view of an exemplary wheelchair drive assembly, in accordance with some embodiments of the present invention, wherein the spring biased cable mechanism is shown in further detail;

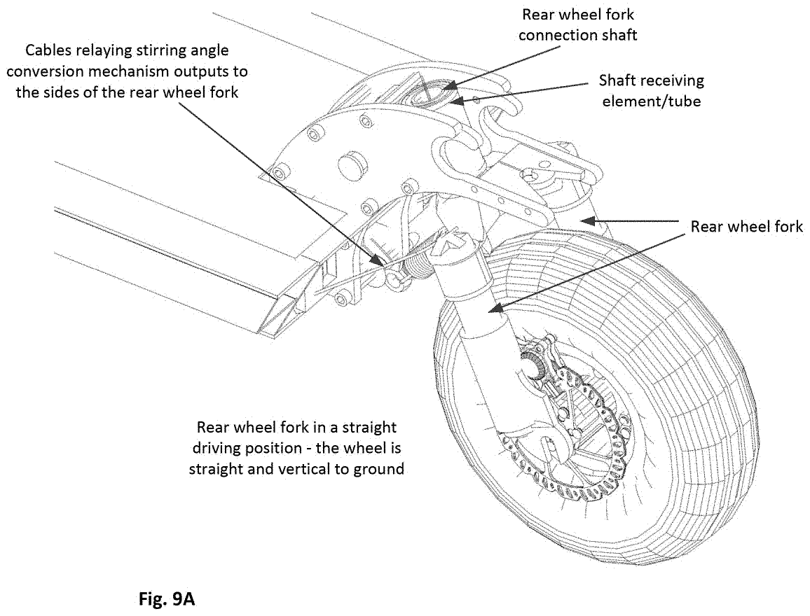

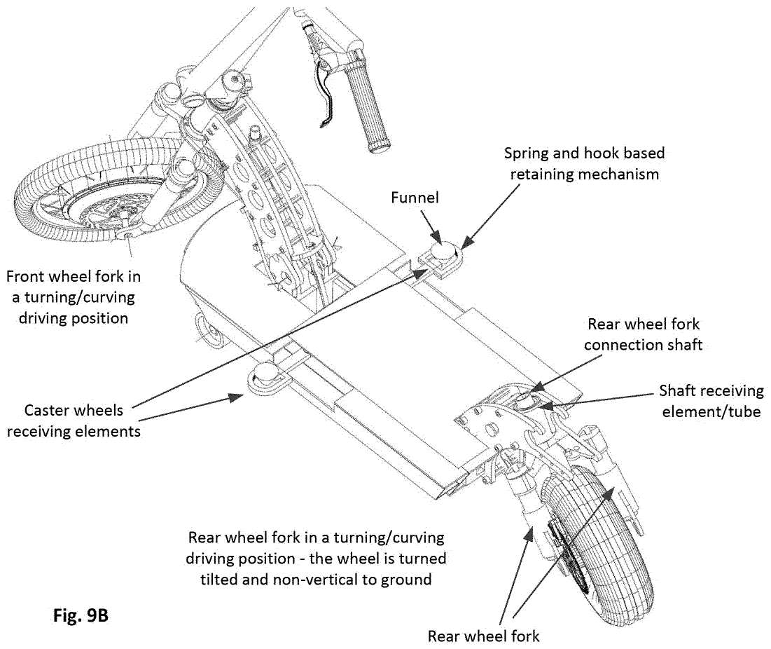

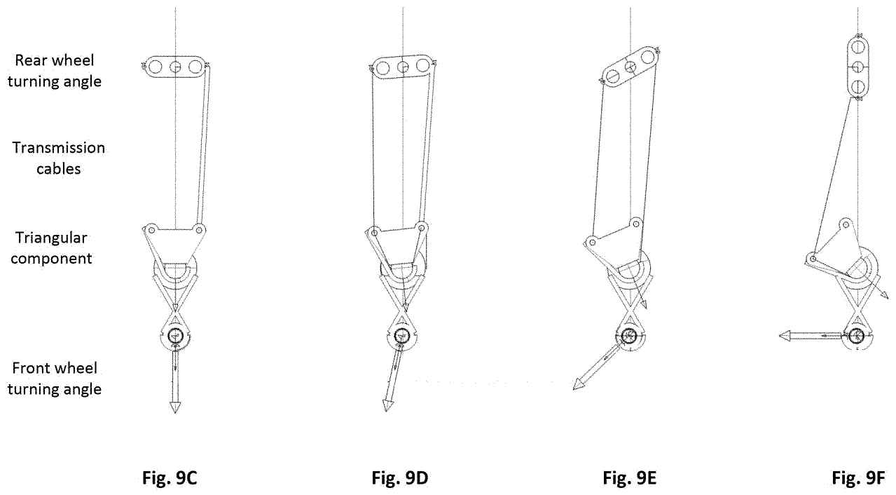

In FIG. 9A, there is shown an exemplary wheelchair drive assembly, in accordance with some embodiments of the present invention, wherein the rear wheel and rear wheel fork are shown in further detail—in a straight driving position;

In FIG. 9B, there is shown an exemplary wheelchair drive assembly, in accordance with some embodiments of the present invention, wherein both the rear wheel and rear wheel fork and, the front wheel and front wheel fork, are shown—in a turning/curving driving position; and

In FIGS. 9C-9F, there is shown an exemplary stirring angle conversion mechanism of a wheelchair drive assembly, in accordance with some embodiments of the present invention, wherein in each of the figures the front wheel angle is represented by the bottom arrow and the rear wheel angle is represented by the wheel fork at the top.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Embodiments of the present invention may include apparatuses for performing the operations herein. Such apparatus may be specially constructed for the desired purposes, or it may comprise of general-purpose components. The processes and components presented herein are not inherently related to any particular embodiment, various general-purpose devices, methods, systems and/or apparatuses may be used in accordance with the teachings herein, or it may prove convenient to construct more specialized devices, methods, systems and/or apparatuses to perform/produce the desired action. The desired structure for a variety of these devices, methods, systems and/or apparatuses will appear from the description below.

Functions, operations, components and/or features described herein with reference to one or more embodiments, may be combined with, or may be utilized in combination with, one or more other functions, operations, components and/or features described herein with reference to one or more other embodiments, or vice versa.

Unless specifically stated otherwise, as apparent from the following discussions, it is appreciated that throughout the specification discussions utilizing terms such as ‘assembly’, ‘detachable assembly’, ‘drive-unit’, ‘unit’, ‘mobility attachment’, ‘attachment’, ‘add-on’, ‘apparatus’, or the like, may refer to a device/unit/system that is detachably connectable to a wheelchair or a rickshaw, while facilitating, improving and/or affecting, mobility thereof. These terms may be interchangeably used herein. Further, the term ‘wheelchair’ may relate to any type, electric or manual, of a human mobilizing system, such as, but not limited to, those utilized for providing mobility and accessibility to handicapped, disabled, injured, or elsewise physically limited subjects.

In some or all of the following descriptions, a specific exemplary wheelchair configuration has been used to describe some of the embodiments of the invention, along with features and operation thereof. It is hereby made clear, that any of the solutions, components, structures and methods in these descriptions, may be likewise applicable to various additional/other wheelchair types and configurations, arid/or to any type, electric or manual, of a human mobilizing system, method, device, and/or apparatus—such as, but not limited to: a rickshaw, a pulled-rickshaw, a cart, a wagon, a trolley, a sled and/or the like.

The mobility solution of the present invention may connect to various different wheelchairs, rickshaws, or the like (e.g. a two wheeled barrow), using the described interconnection mechanism, which will allow it to function as a “Mobility Scooter”. Wherein the detachable mobility assembly of the invention may be used as a two wheeled motorized scooter, while the rider is sitting on a fitted chair, or standing up.

The present invention includes a wheelchair/rickshaw mobility platform, system, method, detachable assembly, drive-unit and a wheelchair/rickshaw interconnection mechanism.

A chassis, of a wheelchair/rickshaw mobility assembly in accordance with some embodiments, may be connected to a front unit and a rear unit, wherein each unit comprises a respective electrically motorized wheel. The chassis may include an interlocking element extending towards and interfacing-with a structural element on the frame of a wheelchair, such that forward force applied onto the chassis by the front and rear wheels, is conveyed to the wheelchair by the interlocking element, thereby propelling it forward.

According to some embodiments, the interlocking element—interfacing-with the structural element on the frame of a wheelchair—may interface/interlock with the axis of the rear wheels of the wheelchair or specific element(s) thereof.

According to some embodiments, the structure of the chassis, and/or the location of the interlocking element thereon, may position the spinning axis of the rear electrically motorized wheel at, or more rearwards/backwards of, the position of the axis of the rear wheels of a wheelchair, interfaced by the interlocking element of the chassis.

Reference is now made to FIG. 1, where there is shown an exemplary wheelchair drive assembly, in accordance with some embodiments of the present invention, wherein the assembly is shown in a perspective view.

In the figure, a chassis is shown to be connected to a front unit and a rear unit—by the shown front unit to chassis and rear unit to chassis connection axles—wherein each unit comprises a respective electrically motorized wheel. The chassis includes an interlocking element extending towards a structural element on the frame of a wheelchair, for interfacing-therewith, such that forward force applied onto the chassis by the front and rear wheels, is conveyed to the wheelchair by the interlocking element, thereby propelling it. The assembly is shown to include handlebars for directing its front and optionally rear, wheel.

Reference is now made to FIG. 2A, where there is shown an exemplary wheelchair drive assembly, in accordance with some embodiments of the present invention, wherein the assembly is shown connected to a wheelchair, in a perspective view.

Reference is now made to FIG. 2B, where there is shown an exemplary wheelchair drive assembly, in accordance with some embodiments of the present invention, wherein the assembly is shown connected to a rickshaw, in a perspective view.

Reference is now made to FIG. 2C, where there is shown an exemplary wheelchair drive assembly, in accordance with some embodiments of the present invention, wherein the assembly is shown connected to a one seat rickshaw, in a side view.

Reference is now made to FIG. 2D, where there is shown an exemplary wheelchair drive assembly, in accordance with some embodiments of the present invention, wherein the assembly is shown connected to a two seat rickshaw, in a perspective view.

Reference is now made to FIG. 2E, where there is shown an exemplary wheelchair drive assembly, in accordance with some embodiments of the present invention, wherein the assembly is shown connected to a one front seat and two back seats rickshaw, in a perspective view.

Reference is now made to figure In FIG. 2F, where there is shown an exemplary wheelchair drive assembly, in accordance with some embodiments of the present invention, wherein the assembly is shown connected to a one front seat and two back seats rickshaw, in a side view.

Reference is now made to figure in FIG. 2G, where there is shown an exemplary wheelchair drive assembly, in accordance with some embodiments of the present invention, wherein the assembly is shown connected to a one front seat and two backward facing back seats rickshaw, in a perspective view.

Reference is now made to figure In FIG. 2H, where there is shown an exemplary wheelchair drive assembly, in accordance with some embodiments of the present invention, wherein the assembly is shown connected to a one front seat and two backward facing back seats rickshaw, in a side view.

According to some embodiments, the front unit of the assembly may include handlebars for pointing the front wheel of the assembly at the direction in which the assembly, and a wheelchair connected thereto, will travel. According to some embodiments, the structure of the handlebars, the chassis and/or the location of the interlocking element thereon, may position the handlebars substantially in front of, and in a reaching distance of, a user sitting in a wheelchair, interfaced by the interlocking element of the chassis. Pushing of the handlebars in substantially a forward direction may yield the application of an unfolding force onto an axle connecting between the front unit and the chassis—thereby increasing the (top/upper) angle between them.

Increasing the angle between the chassis and the front unit at the axle the ‘unfolding movement’—may trigger, activate, generate and/or facilitate any combination of the following assembly actions, in response. The assembly actions may be electrically or mechanically triggered by/upon the ‘unfolding movement’ reaching, or passing, specific one or more threshold angles.

According to some embodiments, the chassis may be connected to the front unit by an axle, wherein increasing the angle between the chassis and the front unit at the axle, raises the caster wheels of a wheelchair, interfaced by the interlocking element of the cassis, off the around.

According to some embodiments, the chassis may be connected to the front unit by an axle, wherein increasing the angle between the chassis and the front unit at the axle, positions the rear unit, and its electrically motorized wheel, more rearwards/backwards in relation to a wheelchair, interfaced by the interlocking element of the chassis.

According to some embodiments, the position of the axis of the rear electrically motorized wheel, in relation to the axis of the rear wheels of a wheelchair interfaced by the interlocking element of the chassis, may be: (1) further frontwards/forwards of the rear wheels axis, upon interface by the interlocking element; and further rearwards/backwards of the rear wheels axis, upon increasing the angle between the chassis and the front unit at the axle; and/or (2) at, or further rearwards/backwards of the rear wheels axis, upon interface by the interlocking element; and yet/even further rearwards/backwards of the rear wheels axis, upon increasing the angle between the chassis and the front unit at the axle.

According to some embodiments, the chassis may be connected to the front unit by an axle, wherein increasing the angle between the chassis and the front unit at the axle, repositions the interlocking element to interface with the frame of a wheelchair, positioned there above, thereby interconnecting the chassis with the wheelchair.

According to some embodiments, the chassis may be connected to the front unit by an axle, wherein increasing the angle between the chassis and the front unit at the axle—that may be referred to herein as an ‘unfolding movement’—may trigger the activation of one or more components or functions of the assembly, such as, but not limited to: (1) the release one or more breaking mechanisms of the assembly's wheels; (2) the closing/connection of an electric switch or circuit providing power to the electrical motor(s) of the front, the rear, or both of the assembly's wheels; (3) the locking/retention of the axle into an increased—chassis to front unit—angle orientation; (4) the repositioning and/or engaging of the interlocking element to interface, or complete the interfacing (e.g. the locking step of a two-step interlocking process including a first positioning step and then a locking step), with the frame of a wheelchair; and/or (5) the activation of one or more other electrical or mechanical components and/or accessories of the assembly, for example: lights, safety devices, communication components, positioning systems, stabilizing mechanisms, user information input/output components and/or others.

Reference is now made to FIG. 3A, where there is shown an exemplary wheelchair drive assembly, in accordance with some embodiments of the present invention, wherein the wheelchair drive assembly is disconnected from a wheelchair positioned behind the assembly, as part of a first stage of a drive assembly to wheelchair interconnection scheme.

In the figure, the assembly is shown to be resting on its front wheel, rear wheel and the shown trolling wheels connected to the front section of the chassis. The wheelchair is resting on its rear wheels and front caster wheels.

The top angle between the front unit and the chassis—at their connection axle—is at a first (parking) value/size.

Reference is now made to FIG. 3B, where there is shown an exemplary wheelchair drive assembly, in accordance with some embodiments of the present invention, wherein the wheelchair drive assembly is disconnected from the wheelchair positioned/advanced over/above the assembly, as part of a second stage of a drive assembly to wheelchair interconnection scheme.

Pushing of the handlebars, from the position shown in the figure, substantially at the direction of the thick arrow, yields the application of an unfolding/straightening force onto the axle connecting between the front unit and the chassis—thereby increasing the (top/upper) angle between them and optionally engaging the interconnecting element of the assembly.

Reference is now made to FIG. 3C, where there is shown an exemplary wheelchair drive assembly, in accordance with some embodiments of the present invention, wherein the wheelchair drive assembly chassis is unfolded/straightened, the wheelchair is interconnected thereto by the interlocking element engaged with the axle of wheelchair's rear wheels, as part of a third stage of a drive assembly to wheelchair interconnection scheme.

In the figure, the assembly and the wheelchair interconnected thereto are shown to be resting on the front wheel and rear wheel of the assembly and the rear wheels of the wheelchair. The trolling wheels (connected to the front of the chassis) and the front caster wheels of the wheelchair (connected, by the unfolding/straightening movement, to corresponding receiving elements in the front of the chassis) have both risen and are positioned above the ground.

The top angle between the front unit and the chassis—at their connection axle—is now at a second (driving), larger than first stage, value/size. At the shown—assembly interconnected to wheelchair—stage, the axle of the assembly's rear wheel is shown to be positioned further back than the axle of the wheelchair's rear wheels.

According to some embodiments, the chassis may be connected to the front unit by an axle, wherein decreasing the angle between the chassis and the front unit at the axle, when the assembly is detached from a wheelchair, raises the front unit and front electrically motorized wheel, to fold up, at the axle, and over the chassis—to a folded storage/trolling position/configuration.

According to some embodiments, the chassis may further be connected, substantially at its front section, to two trolling wheels for stabilizing/supporting the assembly when stored or trolled (i.e. carried/mobilized while not being used). When at a position in which the front unit and front electrically motorized wheel are folded up and over the chassis, as described herein, the assembly may contact the ground at three points/areas—the rear electrically motorized wheel and the two trolling wheels. Lifting the rear electrically motorized wheel when in the folded position, may leave the assembly to contact the ground by only the two trolling wheels, enabling its trolling/carrying/mobilizing over the wheels in a tilted/inclined position.

Reference is now made to FIG. 4A, where there is shown an exemplary wheelchair drive assembly, in accordance with some embodiments of the present invention, wherein the wheelchair drive assembly is shown with its front unit handlebars and front wheel folded (bent backwards over chassis—lying storage position) and, wherein the assembly's small trolling wheels and rear wheel are in contact with the ground.

The top angle between the front unit and the chassis—at their connection axle—is now at a third (storage), smaller than first stage (FIG. 3A), value/size.

Reference is now made to FIG. 4B, where there is shown an exemplary wheelchair drive assembly, in accordance with some embodiments of the present invention, wherein the wheelchair drive assembly is shown with its handlebars and front wheel folded (bent backwards over chassis—standing storage position) and, the assembly's small trolling wheels and front wheel are in contact with the ground.

The assembly's small trolling wheels are shown to be connected to the ending of an extendable shaft, ejected/pulled from within a channel or a track in/on the bottom of the chassis, running along it. The trolling wheels are thus re-located to enable the stable positioning of the assembly over its front and trolling wheels in a standing storage position.

Reference is now made to FIG. 4C, where there is shown an exemplary wheelchair drive assembly, in accordance with some embodiments of the present invention, wherein the wheelchair drive assembly is shown with its handlebars and front wheel folded (bent backwards over chassis—tilted trolling position) and, the assembly's small trolling wheels are in contact with the ground.

The assembly is shown to be trolled/carted away, tilted, over its trolling wheels, by a person holding onto a handle/strap connected to its front wheel/unit.

According to some embodiments, the chassis of the assembly may comprise a bike seat tube/shaft opening, for accepting and retaining a user/rider seat (e.g. a bicycle seat) or a connection element thereof. When detached from a wheelchair, the assembly may accordingly be used as a standalone electric scooter—in a standing position, where the rider stands on the chassis or a platter/feet-placing connected to its top; or, in a seating position, by connection of the bike seat to the assembly's tube/shaft opening.

Reference is now made to FIG. 5, where there is shown an exemplary wheelchair drive assembly, in accordance with some embodiments of the present invention, wherein the wheelchair drive assembly is shown to include a bike seat positioned above the chassis of the assembly and connected thereto.

The drive assembly includes a bike seat tube/shaft opening adapted to accept into it the bike seat tube/shaft and retain it, and the seat connected thereto, in one or more positions/heights (e.g. in a specific height from the floor to accommodate the user's dimensions).

According to some embodiments, the interlocking element may be structured to extend towards, face, guide and/or accept, a structural element of/on the frame, or the axis of the rear wheels, of a wheelchair; such that the structural element of/on the frame of a wheelchair driven forward, over and above the back of the assembly, makes-contact/engages with the extended interlocking element.

According to some embodiments, the interfacing of the interlocking element with the structural element of/on the frame of the wheelchair—to interconnect between the assembly and the wheelchair—may be triggered as a result of the structural element of/on the frame making-contact/engaging with the extended interlocking element.

According to some embodiments, the interlocking element may, for example, comprise a spring and hook based mechanism for interfacing with a structural element of/on the frame of the wheelchair. The exemplary spring and hook mechanism may include a spring biased hook. The hook may be initially push-opened (against spring bias), when contacted/engaged by the structural element of/on the frame of the wheelchair; and then, snapped-over (by spring bias) the wheelchair structural element, to interconnect therewith.

According to some embodiments, a release button/lever/handle—and/or the folding of the axle connecting between the front unit and the chassis (thereby decreasing the (top/upper) angle between them)—may un-interface/disconnect the assembly's interlocking element from the structural element of/on the frame of the wheelchair. Push/pull/turn opening the hook (against spring bias), by engaging the release button/lever/handle, may enable for the structural element of/on the frame of the wheelchair to be withdrawn, for example, by the reverse/back movement of the wheelchair, in the direction of the rear of the assembly.

According to some embodiments, an exemplary interlocking element interfacing mechanism, for interfacing with the structural element of the frame of the wheelchair—to interconnect between the assembly and the wheelchair—may incorporate structures and mechanisms substantially similar to those applied in ‘click-to-lock’ seat belt connection, or child-seat to car-chassis connection mechanisms, as an example.

Reference is now made to FIG. 6A, where there is shown an exemplary wheelchair drive assembly, in accordance with some embodiments of the present invention, wherein the interlocking element, including main components thereof, is shown in greater detail in a disconnected state.

In the figure, the disconnected interlocking element is shown to have its hook mechanism open and ready to accept and lock upon the shown wheelchair rear wheels axle moving in the general direction of the thick arrow and entering the opening of the interconnection mechanism—as the wheelchair advances to position over the mobility assembly.

Reference is now made to FIG. 6B, where there is shown an exemplary wheelchair drive assembly, in accordance with some embodiments of the present invention, wherein the interlocking element, including main components thereof, is shown in greater detail—in an engaged state.

In the figure, the engaged interlocking element is shown to have its hook mechanisms closed and locked over the shown wheelchair rear wheels axle—now positioned within the opening of the interconnection mechanism.

According to some embodiments, the axle, connecting the chassis to the front unit, may comprise a mechanism for retaining/locking the orientation between the chassis and the front unit at one or more predefined axle-angles.

According to some embodiments, the one or more predefined axle-angles may, for example, include any combination of: (1) a folded position—at a first axle angle, wherein the front wheel, rear wheel and trolling wheels of the assembly are in contact with the ground; (2) an unfolded position—at a second axle angle greater than the first axle angle, wherein the front wheel and the rear wheel of the assembly are in contact with the around; (3) a folded storage position—at a third axle angle lesser than the first axle angle, wherein the rear wheel and trolling wheels of the assembly are in contact with the ground and the front wheel, and handlebars, are folded backwards there above; and/or (4) any other position/angle.

Reference is now made to FIG. 7A, where there is shown an exemplary wheelchair drive assembly, in accordance with some embodiments of the present invention, wherein the chassis axle is shown in a folded chassis parking position, with the small trolling wheels on around.

In the figure, the trolling wheels of the assembly are shown to be resting on the ground. A chassis axle element, for retaining/locking the orientation between the chassis and the front unit at one or more predefined axle-angles, is shown to be unengaged/unlocked as the front unit pin is not in position within one of the two pin-complementing grooves in the chassis axle element.

Further shown in the figure are caster wheels receiving elements, connected to both sides of the chassis, or a top standing platter thereof, and adapted to receive and retain the caster wheels of a wheelchair being interconnected to the assembly.

Reference is now made to FIG. 7B, where there is shown an exemplary wheelchair drive assembly, in accordance with some embodiments of the present invention, wherein the chassis axle is shown in an unfolded chassis—locked for driving—position, with the small trolling wheels above ground.

In the figure, the trolling wheels of the assembly are shown to be positioned above the ground. The chassis axle element, for retaining/locking the orientation between the chassis and the front unit at one or more predefined axle-angles, is shown to be engaged/locked as the front unit pin is in position within the bottom one of the two pin-complementing grooves in the chassis axle element.

Further shown in the figure are the caster wheels receiving elements, connected to both sides of the chassis, or a top standing platter thereof, and adapted to receive and retain the caster wheels of a wheelchair being interconnected to the assembly.

In FIG. 7C, there is shown an exemplary wheelchair drive assembly, in accordance with some embodiments of the present invention, wherein the chassis axle is shown, in greater zoom-in, in a bent backwards—storage—position, with the small trolling wheels on ground.

In the figure, the trolling wheels of the assembly are shown to be resting on the ground. The chassis axle element, for retaining/locking the orientation between the chassis and the front unit at one or more predefined axle-angles, is shown to be engaged/locked as the front unit pin is in position within the top one of the two pin-complementing grooves in the chassis axle element.

Further shown in the figure, in greater detail, are the caster wheels receiving elements, connected to both sides of the chassis, or a top standing platter thereof, and adapted to receive and retain the caster wheels of a wheelchair being interconnected to the assembly.

According to some embodiments, the rear unit electrically motorized wheel may be connected to the chassis by a rear wheel fork. According to some embodiments, the rear wheel fork may be connected to the chassis, substantially at its back end/section, by an axis facilitating/forming a circular/circle-segment course for movement, for the rear wheel and fork, around the connection axis.

According to some embodiments, a spring/shock-absorber may connect between the rear wheel fork or the axis of the rear wheel; and, the chassis of the assembly, substantially at its back end/section.

According to some embodiments, the spring/shock-absorber may connect to the chassis at a point substantially at the back end/section of the chassis of the assembly, which point may be located at a position on the chassis which is higher than the position at which the rear wheel fork is connected to the chassis.

According to some embodiments, the spring/shock-absorber may limit the course of movement of the rear wheel fork, and rear wheel, around the axis connecting the fork to the chassis, wherein: the rear wheel is at an uppermost position, in relation to the chassis, when the spring/shock-absorber is fully compressed/squeezed; and, the rear wheel is at a lowermost position, in relation to the chassis, when the spring/shock-absorber is fully extended/stretched-out.

According to some embodiments, the spring/shock-absorber may generate constant downward force on the rear-wheel-fork/rear-wheel, biasing the rear wheel downward onto the ground, causing it to remain in contact, and in traction, with the ground—as the assembly, along with an interconnected wheelchair, travels over non-flat topography, causing for example, for one or both of the rear wheels of the wheelchair to be in contact with the ground, at a position/line higher than the position/line of the back, front, or both/between assembly wheels.

According to some embodiments of the present invention, a spring biased cable mechanism may run along/within the chassis of the assembly, connecting between the front unit and the rear unit or its rear wheel fork.

According to some embodiments, the spring biased cable mechanism may remain substantially loose when the front unit of the assembly is bent/folded—in either a parking position or a storage position, as described herein. Unfolding/straightening the front unit, from a parking position to a driving position, may stretch the cable triggering/flexing its spring mechanism. The cable biased spring, connected to the bottom of the rear wheel fork—that along with rest of the rear unit is connected to the chassis by a rear unit axle—generates/applies a downward force, around the axle and against the ground—on the rear wheel.

The downward force applied to the rear wheel, may: (1) keep the rear wheel in contact with the ground, when the assembly is interconnected to a wheelchair/rickshaw and running over uneven/non-flat/bumpy terrain; (2) support some of, or a greater part of, the weight load put on the assembly's front wheel and/or on the wheels of a wheelchair/rickshaw interconnected thereto; (3) increase the wheel's/tire's traction with the ground, generating greater/better propelment/propulsion as the rear wheel motor spins it; and/or (4) generate shock absorption functionality, wherein the triggered/flexed (assembly in driving position) spring mechanism—further triggers/flexes, increasing the total cable mechanism length, thus enabling the rear wheel to move further up and around the axle, when traveling/driving over elevations/bumps/dents.

Reference is now made to FIG. 8A, where there is shown an exemplary wheelchair drive assembly, in accordance with some embodiments of the present invention, wherein the rear unit and rear wheel are shown in further detail along with a spring biased cable mechanism in a first triggered/flexed position. The spring biased cable mechanism—running along/within the chassis of the assembly, connecting between the front unit and the rear unit or its rear wheel fork—is shown to connect to the bottom rear wheel fork. The assembly is in driving position and the spring mechanism is partially triggered/flexed by the prior unfolding/straightening the front unit, thus generating/applying a downward force—on the rear wheel—around the rear unit axle and against the ground, in the general direction of the thick arrow.

Reference is now made to FIG. 8B, where there is shown an exemplary wheelchair drive assembly, in accordance with some embodiments of the present invention, wherein the rear unit and rear wheel are shown in further detail along with a spring biased cable mechanism in a second, further triggered/flexed, position. The spring biased cable mechanism—running along/within the chassis of the assembly, connecting between the front unit and the rear unit or its rear wheel fork—is shown to connect to the bottom rear wheel fork. The assembly is in driving position and the spring mechanism is further triggered/flexed by an elevation/bump/step encountered by the rear wheel along its driving/advancement route. The encountered elevation/bump/step applies an upward force—on the rear wheel—around the rear unit axle, causing its movement in the general direction of the thick arrow.

In the figure, the distance between the top of the rear wheel and the ‘tail’ of the assembly's interconnection mechanism is shown to be shorter than their distance in FIG. 8A—as the spring mechanism was further triggered/flexed to absorb the elevation/bump/step along the rear wheel's route. The spring mechanism length is shown to be extended as its spring was further triggered/flexed, optionally causing the rear wheel to now press downward against the ground at even a greater force (as the spring is further flexed against its bias).

Reference is now made to FIG. 8C, where there is shown a cross section view of an exemplary wheelchair drive assembly, in accordance with some embodiments of the present invention, wherein the spring biased cable mechanism is shown in further detail. The cable of the mechanism is shown to connect to a cable connection element on the front unit, at one of its sides; ran around a first cable-leading/tracking element; run along the bottom of the chassis; run around a second cable-leading/tracking element; connect to one side of the spring component; and, on the other side of the spring component, connect to the bottom of the rear wheel fork.

Further shown in the figure are the front unit axle and the rear unit axle. As the front unit is opened/unfolded into driving position the cable of the mechanism is pulled forward, causing the rear unit to likewise open/unfold (increasing the top angle between itself and the chassis) as the rear unit is pulled downward and the rear wheel pushes against the ground.

At the section of the spring biased cable mechanism that is running along the bottom of the chassis, there is shown an optional user compatibility component, adapted—for example by utilizing a combination of screw elements or other known cable tightening/shortening techniques—to shorten or lengthen the cable in order to accommodate users and/or wheelchairs/rickshaws of different weight and/or weight distributions.

According to some embodiments, the cable may be shortened and lengthened in relation to the amount of weight applied to the rear wheel, wherein the more weight is applied the further the cable is shortened/tightened.

According to some embodiments, the rear wheel fork may be connected to the chassis by a rear wheel connection shaft, wherein the rear wheel is connected by an axle to the connection shaft on its lower/rear side; and, the connection shaft, on its upper/front side, is pivotally connected to a receiving element on the chassis.

According to some embodiments, the connection shaft may connect to the chassis at a non-perpendicular/sharp angle.

According to some embodiments, the turning of the assembly's front wheel (e.g. using the handlebars) at a first specific angle—for example, as it is moving forward and interconnected with a wheelchair triggers a stirring angle conversion mechanism, making the rear wheel connection shaft, and rear wheel connected thereto, turn within the receiving element on the chassis, at a second specific angle which is the result of the conversion of the first specific angle—thereby repetitively/continually setting the rear wheel turning angle based-on/in-relation-to front wheel turning angle values.

According to some embodiments, the stirring angle conversion mechanism may implement a non-linear conversion formula, wherein the change of the rear wheel turning angle output, is not proportional to the change of the input rear wheel turning angle.

According to some embodiments, the stirring angle conversion mechanism may implement a non-linear conversion formula, wherein—throughout the range of the front wheel's possible turning angles—the relayed rear wheel turning angle output is either smaller than, or equal to, the respective front wheel turning angle input which it is based on.

According to some embodiments, the turning of the connection shaft within the receiving element on the chassis may be limited by a rear wheel turning limiter/stopper for example in the form of a pin or a knob having a limited track of movement within a complementary hole or moves—preventing the turning of, the non-perpendicularly connected, connection shaft over a certain extent, thus also limiting the maximum turn and inward tilt angle of the rear wheel as the assembly, and wheelchair connected thereto, are turning.

According to some embodiments, the turning of the connection shaft may be limited to a specific value corresponding to a respective rear wheel tilt. For example, the turning of the connection shaft may be limited to allow for the rear wheel a maximal tilt of, or roughly about, 30 degrees from vertical.

Reference is now made to FIG. 9A, where there is shown an exemplary wheelchair drive assembly, in accordance with some embodiments of the present invention, wherein the rear wheel and rear wheel fork are shown in further detail—in a straight driving position.

Further shown in the figure is the rear wheel/fork connection shaft inside its receiving element; and the cables, relaying stirring angle conversion mechanism outputs to the sides of the rear wheel fork, thus turning the rear wheel in accordance with conveyed front wheel turning angle inputs.

Reference is now made to FIG. 9B, where there is shown an exemplary wheelchair drive assembly, in accordance with some embodiments of the present invention, wherein both the rear wheel and rear wheel fork and, the front wheel and front wheel fork, are shown—in a turning/curving driving position.

The turning angle of the front wheel—the input angle of the stirring angle conversion mechanism; is shown, to be greater than the turning angle of the rear wheel—the output angle of the stirring angle conversion mechanism. Further shown in the figure is the rear wheel/fork connection shaft inside its receiving element.

Further shown in the figure are the caster wheels receiving elements, connected to both sides of the chassis and/or its top standing platter, and adapted to receive and retain the caster wheels of a wheelchair being interconnected to the assembly. Each of the exemplary caster wheels receiving elements shown, includes a funnel for leading a respective connection pin—attached to each of a wheelchair's caster wheels forks by strapping, screwing, clamping and/or other attachment element(s)—into a spring and hook based retaining mechanism, for example, similar mechanism used for the closed retention/locking of a car's engine hood.

The shown caster wheels receiving elements may, in accordance with some embodiments, close when not in use (not interconnected to wheelchair). The caster elements may be folded backwards towards a parallel position in relation to the chassis; and/or may be pushed inwards along a track/channel/groove/notches on/in: the chassis, each or both of the two opposite caster elements' connection arms and/or both.

Reference is now made to FIGS. 9C-9F where there is shown an exemplary stirring angle conversion mechanism of a wheelchair drive assembly, in accordance with some embodiments of the present invention, wherein in each of the figures the front wheel angle is represented by the bottom arrow and the rear wheel angle is represented by the wheel fork at the top. The mechanism is shown in: a straight (0°) front wheel angle (FIG. 9C), a turned front wheel angle (FIG. 9D), a sharply turned front wheel angle (FIG. 9E) and a fully turned (90°) front wheel angle (FIG. 9F).

The turning angles outputs of the rear wheel—based on the conversion of their corresponding front wheel's turning angles inputs above, by the structure of the triangular component and the transmission cables running there through, relaying stirring angle outputs to the sides of the rear wheel fork—are as follows: a straight (0°) rear wheel angle (FIG. 9C), an only slightly turned rear wheel angle (FIG. 9D), a slightly less sharply turned rear wheel angle (FIG. 9E) and a fully turned (90°) rear wheel angle (FIG. 9F).

According to some embodiments of the present invention, a detachable wheelchair drive assembly (Electric Mobility Attachment) may comprise: A chassis connected to a front and rear unit, each unit comprising a respective electrically motorized wheel; Wherein the chassis includes an interlocking element extending towards and interfacing-with a structural element on the frame of a wheelchair, such that forward force applied onto the chassis by the front and rear wheels, is conveyed to the wheelchair by the interlocking element, thereby propelling it forward.

According to some embodiments, the chassis may be connected to the front unit by an axle, and wherein increasing the angle between the chassis and the front unit at the axle, repositions the interlocking element to interface with the frame of a wheelchair (positioned there above), thereby interconnecting the chassis to the wheelchair.

According to some embodiments, the detachable wheelchair drive assembly may further comprise handlebars connected to the front unit, wherein application of an unfolding forward force onto the handlebars increases the angle between the chassis and the front unit at the axle.

According to some embodiments, the chassis may be connected to the front unit by an axle, and wherein increasing the angle between the chassis and the front unit at the axle, positions the front caster wheels of the wheelchair above ground.

According to some embodiments, the detachable wheelchair drive assembly may comprise handlebars connected to the front unit, wherein application of an unfolding forward force onto the handlebars increases the angle between the chassis and the front unit at the axle.

According to some embodiments, upon the interlocking element interfacing-with a structural element on the frame of the wheelchair, the spinning axis of the rear unit motorized wheel may be positioned along with, or further back of, the position of the axis of the rear wheels of the interfaced wheelchair.

According to some embodiments, increasing the angle between the chassis and the front unit at the axle, may further trigger the release of one or more breaking mechanisms of the assembly's wheels.

According to some embodiments, increasing the angle between the chassis and the front unit at the axle, may further trigger the connection of an electric switch or circuit providing power to the electrical motor(s) of the front, the rear, or both of the assembly's wheels.

According to some embodiments, increasing the angle between the chassis and the front unit at the axle, further triggers the locking of the axle into an increased—chassis to front unit—angle orientation.

According to some embodiments 1 increasing the angle between the chassis and the front unit at the axle, triggers the locking of the interlocking element, on the interfaced frame element of a wheelchair.

According to some embodiments the detachable wheelchair drive assembly may further comprise a spring biased cable mechanism running along or within the chassis of the assembly, connecting between the front unit and the rear unit and, wherein the rear unit is connected to the chassis by a rear unit axle.

According to some embodiments, increasing the angle between the chassis and the front unit at the front unit axle, may further trigger the stretching of the cable of the spring biased cable mechanism, partially flexing of its spring and generating a downward force on the rear unit that pushes the rear wheel—around the rear unit axle—against the ground.

According to some embodiments, the spring of the spring biased cable mechanism may be adapted to further flex in response to an upward force exerted on the rear wheel, thus enabling the rear unit to further travel upwards—around the rear unit axle thereby absorbing exerted upwards forces on the rear wheel, resulting from elevations or bumps in its course.

According to some embodiments, the detachable wheelchair drive assembly may further comprise a stirring angle conversion mechanism for turning the rear wheel at a second specific angle, wherein the second specific angle is the result of the conversion of a specific first angle at which the front wheel is turned.

According to some embodiments, the stirring angle conversion mechanism may implement a non-linear conversion formula, where a given change of the rear wheel turning angle output, is not proportional to a given change of the input of the rear wheel turning angle.

According to some embodiments, the stirring angle conversion mechanism implements a non-linear conversion formula, wherein—throughout the range of the front wheel's possible turning angles—the relayed the rear wheel turning angle output is either smaller than, or equal to, the respective the front wheel turning angle input which it is based on.

The subject matter described above is provided by way of illustration only and should not he constructed as limiting. While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A detachable wheelchair drive assembly (Electric Mobility Attachment) comprising:
A chassis connected to a front and rear unit, each unit comprising a respective electrically motorized wheel; and
Wherein said chassis includes an interlocking element extending towards and interfacing-with a structural element on the frame of a wheelchair, such that forward force applied onto said chassis by said front and rear wheels, is conveyed to the wheelchair by said interlocking element, thereby propelling it forward.

2. The detachable wheelchair drive assembly of claim 1, wherein said chassis is connected to said front unit by an axle, and wherein increasing the angle between said chassis and said front unit at the axle, repositions said interlocking element to interface with the frame of a wheelchair (positioned there above), thereby interconnecting said chassis to the wheelchair.

3. The detachable wheelchair drive assembly of claim 2, further comprising handlebars connected to said front unit, wherein application of an unfolding forward force onto said handlebars increases the angle between said chassis and said front unit at the axle.

4. The detachable wheelchair drive assembly of claim 1, wherein said chassis is connected to said front unit by an axle, and wherein increasing the angle between said chassis and said front unit at the axle, positions the front caster wheels of the wheelchair above ground.

5. The detachable wheelchair drive assembly of claim 4, further comprising handlebars connected to said front unit, wherein application of an unfolding forward force onto said handlebars increases the angle between said chassis and said front unit at the axle.

6. The detachable wheelchair drive assembly of claim 1, wherein upon said interlocking element interfacing-with a structural element on the frame of the wheelchair, the spinning axis of said rear unit motorized wheel is positioned along with, or further back of, the position of the axis of the rear wheels of the interfaced wheelchair.

7. The detachable wheelchair drive assembly of claim 2, wherein increasing the angle between said chassis and said front unit at the axle, further triggers the release of one or more breaking mechanisms of said assembly's wheels.

8. The detachable wheelchair drive assembly of claim 2, wherein increasing the angle between said chassis and said front unit at the axle, further triggers the connection of an electric switch or circuit providing power to the electrical motor(s) of said front, said rear, or both of the said assembly's wheels.

9. The detachable wheelchair drive assembly of claim 2, wherein increasing the angle between said chassis and said front unit at the axle, further triggers the locking of the axle into an increased—chassis to front unit—angle orientation.

10. The detachable wheelchair drive assembly of claim 2, wherein increasing the angle between said chassis and said front unit at the axle, triggers the locking of said interlocking element, on the interfaced frame element of a wheelchair.

11. The detachable wheelchair drive assembly of claim 2, further comprising a spring biased cable mechanism running along or within said chassis of said assembly, connecting between said front unit and said rear unit and, wherein said rear unit is connected to said chassis by a rear unit axle; and
wherein increasing the angle between said chassis and said front unit at the front unit axle, further triggers the stretching of the cable of said spring biased cable mechanism, partially flexing of its spring and generating a downward force on said rear unit that pushes said rear wheel—around the rear unit axle—against the ground.

12. The detachable wheelchair drive assembly of claim 11, wherein the spring of said spring biased cable mechanism is adapted to further flex in response to an upward force exerted on said rear wheel, thus enabling said rear unit to further travel upwards—around the rear unit axle—thereby absorbing exerted upwards forces on said rear wheel, resulting from elevations or bumps in its course.

13. The detachable wheelchair drive assembly of claim 2, further comprising a stirring angle conversion mechanism for turning said rear wheel at a second specific angle, wherein said second specific angle is the result of the conversion of a specific first angle at which said front wheel is turned.

14. The detachable wheelchair drive assembly of claim 13, wherein said stirring angle conversion mechanism implements a non-linear conversion formula, where a given change of said rear wheel turning angle output, is not proportional to a given change of the input of said rear wheel turning angle.

15. The detachable wheelchair drive assembly of claim 14, wherein said stirring angle conversion mechanism implements a non-linear conversion formula, wherein—throughout the range of said front wheel's possible turning angles—the relayed said rear wheel turning angle output is either smaller than, or equal to, the respective said front wheel turning angle input which it is based on.
